(19) United States
(12) Patent Application Publication
(10) Pub. No.: US 2017/0147485 A1
(43) Pub. Date: May 25, 2017

(54) METHOD AND SYSTEM FOR OPTIMIZING SOFTWARE TESTING PROCESS

(71) Applicant: Wipro Limited, Bangalore (IN)

(72) Inventors: Venkata Subramanian Jayaraman, Chennai (IN); Sumithra Sundaresan, Chennai (IN)

(21) Appl. No.: 14/994,841

(22) Filed: Jan. 13, 2016

(30) Foreign Application Priority Data
Nov. 24, 2015 (IN) 6322/CHE/2015

(51) Int. Cl. G06F 11/36

(52) U.S. Cl. CPC G06F 11/3692; G06F 11/3684; G06F 11/3688

(57) ABSTRACT

Embodiments of the present disclosure disclose a method and a device for optimizing software testing process. The method comprises receiving input data from one or more test management systems and one or more project complexity systems. The method also comprises computing an effort index value by correlating the input data based on at least one parameter associated with the one or more project complexity systems. The method further comprises obtaining an effectiveness value based on the effort index value and the input data and optimizing the software testing process by computing a usefulness value associated with the input data and the effectiveness value.

This application claims the benefit of Indian Patent Application Serial No. 6322/CHE/2015 filed Nov. 24, 2015, which is hereby incorporated by reference in its entirety.

### TECHNICAL FIELD

The present subject matter is related, in general to testing process and more particularly, but not exclusively to a method and a system for optimizing software testing process.

### BACKGROUND

In the recent past moving towards digital transformation, testing is becoming a bottle neck for most of the corporates/customers. The digital transformation means changes associated with an application of digital technology in all aspects of human activities becoming more agile and simplifying the solution. The digital transformation and implementing of digital strategy has a few key criteria to be taken care, such as, but not limited to assurance to business for the success, improve the overall customer experience, increase the speed of testing and provide return on investments and process simplification or making the process lean.

In general, assurance of business is taken care by adapting the right methodology and technology to handle the situation. Improved customer experience is made available by providing proper methodologies and metrics which help in the overall experience. All methodologies in common have defined sets of process that needs to be always followed and the choice of not doing a process is left to the individual teams to decide. It does not simplify the overall process, the list of few activities or processes that may happen immaterial of the methodology for any project are business review, business meeting, requirements review, design review, TC creation, test data setup, TC execution, UAT TC review, UAT support, Production support.

However, to make a process simpler some of the activities have to be sacrificed or eliminated. Currently, the software industry does not have a methodology to simplify the overall process.

### SUMMARY

In an aspect of the present disclosure, a method for optimizing software testing process is provided. The method comprises receiving input data from one or more test management systems and one or more project complexity systems. Then, the method comprises computing an effort index value by correlating the input data based on at least one parameter associated with the one or more project complexity systems. Further, the method comprises obtaining an effectiveness value based on the effort index value and the input data and optimizing the software testing process by computing a usefulness value associated with the input data and the effectiveness value.

In an embodiment of the present disclosure, a testing process computing system for optimizing software testing process is provided. The testing process computing system comprises a processor and a memory communicatively coupled to the processor. The memory stores processor-executable instructions, which, on execution, causes the processor to receive input data from one or more test management systems and one or more project complexity systems, compute an effort index value by correlating the input data based on at least one parameter associated with the one or more project complexity systems, obtain an effectiveness value based on the effort index value and the input data and optimize the software testing process by computing a usefulness value associated with the input data and the effectiveness value.

In another aspect of the present disclosure, a non-transitory computer readable medium is disclosed. The non-transitory computer readable medium includes instructions stored thereon that when processed by a processor causes a device to perform operations comprising receiving input data from one or more test management systems. The operations further comprise identifying at least one behavior model based on the input data. The operations further comprise correlating the at least one behavior model with at least one of affected parameters to determine one or more performance issues in the input data and verifying the one or more performance issues by reassessing the at least one behavior model.

In another aspect of the present disclosure, a non-transitory computer readable medium is disclosed. The non-transitory computer readable medium includes instructions stored thereon that when processed by at least one processor cause a system to perform operations comprising receiving input data from one or more test management systems and one or more project complexity systems. The operations also comprise computing an effort index value by correlating the input data based on at least one parameter associated with the one or more project complexity systems. The operations further comprise obtaining an effectiveness value based on the effort index value and the input data and optimizing the software testing process by computing a usefulness value associated with the input data and the effectiveness value.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of device or system and/or methods in accordance with embodiments of the present subject matter are now described, by way of example only, and with reference to the accompanying figures, in which:

FIG. 1 illustrates a block diagram of an exemplary a testing process computing device for optimizing software testing process in accordance with some embodiments of the present disclosure;

FIG. 2 illustrates an exemplary block diagram of an effectivizer module (alternatively referred as process/project effect calculator) in accordance with some embodiments of the present disclosure;

FIG. 3 illustrates an exemplary block diagram of an optimizer module in accordance with some embodiments of the present disclosure;

FIG. 4 shows a flowchart illustrating a method for optimizing software testing process in accordance with some embodiments of the present disclosure; and

FIG. 5 illustrates a block diagram of an exemplary computer system for implementing embodiments consistent with the present disclosure.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a device or system or apparatus proceeded by “comprises . . . a” does not, without more constraints, preclude the existence of other elements or additional elements in the device or system or apparatus.

Embodiments of the present disclosure are related to a method and a computing system for optimizing software testing process. The system receives input data, for example number of defects, number of activities, number of test cases, amount of effort associated with one or more projects from test management systems. The system also receives a complexity value, associated with one or more projects from one or more project complexity systems. The system analyzes the input data for computing a usefulness value of each activity of the one or more projects. Further, the device optimizes the software testing process and provides a detailed view usefulness values.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

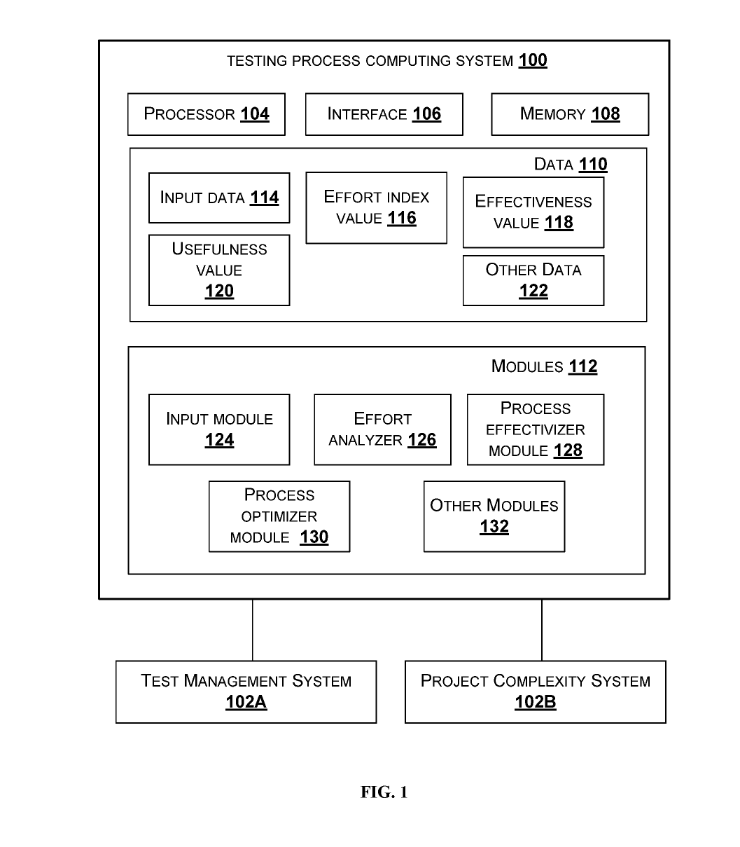

FIG. 1 illustrates a block diagram of an exemplary testing process computing device or system 100 for optimizing software testing process in accordance with some embodiments of the present disclosure. The testing process computing device 100 is communicatively connected to at least one of a test management system 102A and a project complexity system 102B. Examples of the test management system 102A may include, but not limited to, application lifecycle management (ALM) module, application server, and testing modules. It may be understood by a person skilled in the art that any other third party test management system can be used with method of the present disclosure.

The testing process computing device 100 may include at least one central processing unit (“CPU” or “processor”) 104 and a memory 108 storing instructions executable by the at least one processor 104. The processor 104 may comprise at least one data processor for executing program components for executing user- or system-generated requests. A user may include a person, a person using a device such as those included in this disclosure, or such a device itself. The memory 108 is communicatively coupled to the processor 104. In an embodiment, the memory 108 stores data associated with the testing process for optimizing software or application testing process. The testing process computing device 100 further comprises an I/O interface 106. The I/O interface 106 is coupled with the processor 104 through which the input is received.

In an embodiment, one or more data 110 may be stored within the memory 108. The one or more data 110 may include, for example, input data 114, effort index value 116, effectiveness value 118, usefulness value 120, and other data 122.

In an embodiment, the input data 114 comprises input from the test management system 102. The input data may be, for example, number of defects, number of test cases and amount of effort consumed for each of plurality of activities associated with one or more projects, from one or more test management systems. Also, the input data may be, at least one complexity value received from one or more project complexity systems. The input data, number of defects is also referred as total defects corresponding to the defects that are captured in each of the one or more projects. In one embodiment, each of the plurality of activities may or may not result in defects, for which arbitrary values are provide are captured and stored for further use by the system.

For the input data 114, number of test cases which is also referred as total test cases corresponds to the test cases that were performed during a process of an activity. In an example embodiment, there may be activities such as, but not limited to, a business review and a document review process in which no test cases are required. The total test cases in such scenario may be zero or not available.

For the input data 114, amount of effort consumed which is also referred as total effort consumed by each of the activity is received as input data from one or more effort management systems. Each activity may have a start date, an end date and total number of people who worked.

The effort index value 116 is generated using the input data 114. In an embodiment, effort index value 116 is generated by correlating the input data 114 based on a complexity value associated with the one or more project complexity systems.

The effectiveness value 118 is determined based on the effort index value 116 and the input data 114. This is determined by computing an intermediate effectiveness value for each activity of the one or more projects, using number of test cases, number of defects and effort index value associated with corresponding activity of the one or projects. Thereafter, by computing an average of intermediate effectiveness values associated with an activity for one or more projects, the average value is the effectiveness value 118.

In an embodiment, the data 110 in the memory 108 is processed by the modules 112 of the processor 104. The modules 112 may be stored within the memory 108. Also, the modules can be implemented in any suitable hardware, software, firmware, or combination thereof.

In one implementation, the modules may include, for example, an input module 124, effort analyzer 126, a process effectivizer module 128 (alternatively referred as process/project effect calculator), and a process optimizer module 130. The performance testing device 100 may also comprise other modules 132 to perform various miscellaneous functionalities of the device 100. It will be appreciated that such aforementioned modules may be represented as a single module or a combination of different modules.

In an embodiment, the input module 124 receives input data 114 from the test management system 102 and the complexity project system 102. The input data 124 received by the input module 124 is total defects, total test cases and effort consumed. Also, each of the one or more projects comprises plurality of activities, such as, but not limited to business review, business meetings, requirements review, design review, test case (TC) creation, test data setup, TC execution, user acceptance testing (UAT) TC review, UAT support and production support. In one embodiment, the input module 124 receives input data 114 from plurality of test management system 102 using handshaking. It may be understood that at least one or a combination of multiple systems can be used with the present disclosure.

Each of the activities would result in some defects that would be logged in the test management systems. Each of the activities in testing would have at least one test cases associated to them. For below tables show examples of input data 114, Table A shows an illustration of details of the total defects logged for projects A to I, which comprises various activities 1 to 5.

TABLE A

| | Activities | | | | |
|---|---|---|---|---|---|
| Project | Activity 1 | Activity 2 | Activity 3 | Activity 4 | Activity 5 |
| A | 10 | 5 | 50 | 25 | 0 |
| B | 20 | 4 | 4 | 3 | 5 |
| C | 304 | 43 | 4 | 45 | 7 |
| D | 5 | 5 | 4 | 6 | 8 |
| E | 5 | 5 | 6 | 465 | 9 |
| F | 2 | 3 | 5 | 6 | 7 |
| G | 23 | 1234 | 5 | 5 | 4 |
| H | 12 | 234 | 54 | 65 | 7 |
| I | 4 | 5 | 6 | 7 | 8 |

For example, below Table B shows an illustration of details of the total test cases performed during an activity for projects A to I. There could be activities where no test cases might be needed for example a business review or a document review process. In that case a value NA is included.

TABLE B

| | Activities | | | | |
|---|---|---|---|---|---|
| Projects | Activity 1 | Activity 2 | Activity 3 | Activity 4 | Activity 5 |
| A | 1 | 100 | 50 | 25 | 123 |
| B | 1 | 500 | 4 | 3 | 435 |
| C | 1 | 25 | 4 | 45 | 7 |
| D | 1 | 1 | 1 | 6 | 8 |
| E | 1 | 12 | 6 | 465 | 9 |
| F | 1 | 235 | 5 | 6 | 7 |
| G | 1 | 45 | 5 | 1 | 4 |
| H | 1 | 67 | 54 | 65 | 7 |
| I | 1 | 789 | 6 | 7 | 1 |

Table C shows an illustration about details of total effort consumed in hours by each activity for projects A to I.

TABLE C

| | Activities | | | | |
|---|---|---|---|---|---|
| Projects | Activity 1 | Activity 2 | Activity 3 | Activity 4 | Activity 5 |
| A | 30 | 235 | 45 | 234 | 5 |
| B | 40 | 40 | 40 | 78 | 89 |
| C | 50 | 235 | 456 | 568 | 345 |
| D | 790 | 790 | 234 | 32 | 56 |
| E | 384 | 384 | 345 | 345 | 7323 |
| F | 6984 | 6984 | 6984 | 6984 | 780 |
| G | 458 | 458 | 458 | 456 | 678 |
| H | 38 | 38 | 38 | 67 | 89 |
| I | 659 | 34 | 567 | 67 | 789 |

The effort analyzer 126 receives input data 114 from the input module 124 and co-relates and then performs normalization of the efforts. The effort analyzer 126 performs computation of effort based on the project complexity received from the input module 124 through project complexity system 102B. The input data 114 received by the effort analyzer comprises the data of Tables A, B and C i.e. the total effort values, total days and total number of people working for total hours. All the values mentioned in the tables A, B and C is static. However, in real time scenario the complexity of the project plays a major part in determining the effort index value 116. In order to nullify the complexity and an even average is taken as shown below in Table D, which shows an illustration of A sample of the project type complexity.

TABLE D

| | Complexity |
|---|---|
| Project Type | Level |
| Simple/Low | 1 |
| Medium | 1.5 |
| Complex | |
| Complex | 2 |

In one embodiment, the amount of effort or effort consumed or total effort values are received as input data 110 from the project complexity system, before normalization, is provided as input to the effort analyzer 126, which computes an effort index value 116 of each of the activity for the one or more projects. The Table E shows an illustration of the values of the effort consumed before normalization along with the complexity of the project.

TABLE E

| | Activities | | | | | |
|---|---|---|---|---|---|---|
| Effort | Activity | Activity | Activity | Activity | Activity | Project |
| Projects | 1 | 2 | 3 | 4 | 5 | Complexity |
| A | 30 | 235 | 45 | 234 | 5 | 1 |
| B | 40 | 40 | 40 | 78 | 89 | 1 |
| C | 50 | 235 | 456 | 568 | 345 | 1.5 |
| D | 790 | 790 | 234 | 32 | 56 | 1.5 |
| E | 384 | 384 | 345 | 345 | 7323 | 1.5 |
| F | 6984 | 6984 | 6984 | 6984 | 780 | 2 |
| G | 458 | 458 | 458 | 456 | 678 | 2 |
| H | 38 | 38 | 38 | 67 | 89 | 2 |
| I | 659 | 34 | 567 | 67 | 789 | 2 |

The effort analyzer 126 performs normalization using project complexity on the data provided in Table E with the equation mentioned below:

Normalized Effort=Effort by activity/Project complexity

As an example, in the Table E, the activity value Project I activity 1 had a total effort of 659, but the complexity of the project was 2. So, the calculated normalized effort of the project I, Activity 1 is 659/2=329. As illustrated in Table F below, the effort index value is adjusted based on the complexity of the project for each of the activity.

TABLE F

| | Activities | | | | |
|---|---|---|---|---|---|
| Projects | Activity 1 | Activity 2 | Activity 3 | Activity 4 | Activity 5 |
| A | 30 | 235 | 45 | 234 | 5 |
| B | 40 | 40 | 40 | 78 | 89 |
| C | 33.33 | 156.67 | 304 | 378.67 | 230 |
| D | 526.67 | 526.67 | 156 | 21.33 | 37.33 |
| E | 256 | 256 | 230 | 230 | 4882 |
| F | 3492 | 3492 | 3492 | 3492 | 390 |
| G | 229 | 229 | 229 | 228 | 339 |
| H | 19 | 19 | 19 | 33.5 | 44.5 |
| I | 329.5 | 17 | 283.5 | 33.5 | 394.5 |

The process effectivizer module 128 receives the computed effort index value from the effort analyzer 126 and the input data, to calculate the overall effectiveness of the activity based on the complexity and normalized effort of the one or more projects. The process effectivizer module 128 calculates the overall effectiveness of the activity based on the complexity and normalized effort of the project. For each activity of the one or more projects, the process effectivizer module 128 computes an intermediate effectiveness value using number of test cases, number of defects and effort index value 116 associated with corresponding activity of the one or projects. Then, an effectiveness value 118 for each activity is obtained by computing an average of intermediate effectiveness values associated with an activity for one or more projects. The intermediate effectiveness value is computed using the equation below:

Effectiveness:=(Total test case/Total defects)*Effort after adjustment of the complexity

For example, for project G and activity 5 as shown in the Table F, total test cases are 7, total defects are 7 and the normalized effort value or effort index value is 339. So, the effectiveness value is (7/7)*339 which is 339. The average intermediate effectiveness value of each of the activity for all the projects is obtained to compute the actual effectiveness value 118 of the activity for all the projects.

Table G shows an illustration of the intermediate effectiveness value of each of the activity average effectiveness which is calculated based on the normalized effort.

TABLE G

| | Activities | | | | |
|---|---|---|---|---|---|
| Projects | Activity 1 | Activity 2 | Activity 3 | Activity 4 | Activity 5 |
| A | 3 | 4700 | 45 | 234 | 0 |
| B | 2 | 5000 | 40 | 78 | 7743 |
| C | 0.110 | 91.09 | 304 | 378.67 | 230 |
| D | 105.33 | 105.33 | 39 | 21.33 | 37.33 |
| E | 51.2 | 614.4 | 230 | 230 | 4882 |
| F | 1746 | 273540 | 3492 | 3492 | 390 |
| G | 9.96 | 8.35 | 229 | 45.6 | 339 |
| H | 1.58 | 5.44 | 19 | 33.5 | 44.5 |
| I | 82.375 | 2682.6 | 283.5 | 33.5 | 49.31 |
| Average | 222.40 | 31860.8 | 520.17 | 505.18 | 1523.91 |

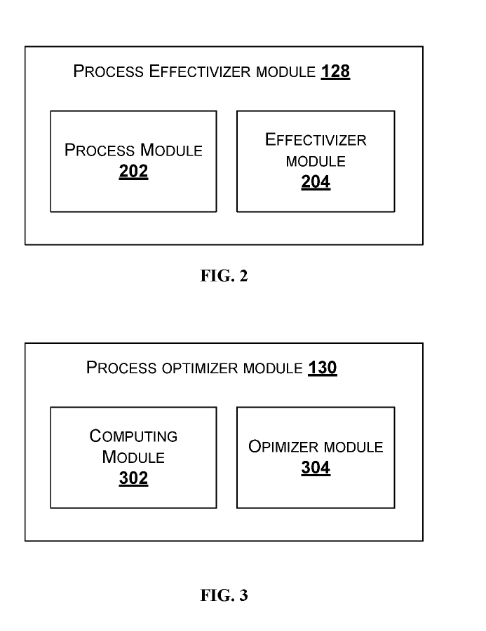

The sub modules of the process effectivizer module 128 are illustrated in FIG. 2. The sub modules of the process effectivizer module 128 comprise a process module 202 and an effectivizer module 204.

The process module 202 processes the input data 114 i.e. number of test cases, number of defects and effort index value 116 associated with each activity of the one or projects and effort index value 116 associated with each activity of the one or more projects, in an exemplary embodiment of the present disclosure. Also, the process module 202 computes an intermediate effectiveness value for each activity of the one or more projects, using the processed input data. The effectivizer module 204 computing an average of intermediate effectiveness values associated with each activity for one or more projects and obtains an effectiveness value 118 of each activity.

Referring back to FIG. 1, process optimizer module 130 is responsible for determining the usefulness of each activity and eliminating an activity for the one or more projects, which is least effective. The process optimizer module 130 receives effectiveness value 118 associated with each activity of the one or more projects computed by the process effectivizer module 128.

The determined average project effectiveness values in process effectivizer module 128 are provided to the process optimizer module 130, to determine usefulness value of each activity. The usefulness value information is about how many times the same activity was performed by the same project in previous instances, which is provided by the input module which receives the information from the test management systems 102A. The activities usefulness is determined by computing overall effectiveness of each activity by total number of times activity was performed based on historical reference data.

For example, considering an activity 1 is performed in a project A for 5 times, then 5 is taken as a reference. The reference is required to make sure that the same process is done multiple times and hence the effectiveness of the process is a derivative of number of times the activity is being performed. The total number of time an activity is performed is obtained from historical reference, taken from the test management systems 102A. The effectiveness value or average effectiveness of an activity is obtain from Table G. The usefulness of an activity is obtained using the equation:

Usefulness of an activity=Average effectiveness/total number of times an activity was performed.

A table H shows an illustration of the usefulness value 120 of each activity, which is determined by the overall effectiveness of the activity by total no of times activity was performed based on historical reference.

TABLE H

| | Total times activity | | |
|---|---|---|---|
| | performed in | | Usefulness of |
| Activity | previous instances | Effectiveness | Activity |
| Activity 1 | 5 | 222 | 44.4 |
| Activity 2 | 5 | 31860 | 6372 |
| Activity 3 | 5 | 520 | 104 |
| Activity 4 | 5 | 505 | 101 |
| Activity 5 | 2 | 1523 | 761.5 |

The table H shows the activities and their ranks based on the usefulness value 120 from highest to lowest as shown in Table I.

TABLE I

| Activity | Usefulness value | Rank |
|---|---|---|
| Activity 2 | 6372 | 1 |
| Activity 5 | 761.5 | 2 |
| Activity 3 | 104 | 3 |
| Activity 4 | 101 | 4 |
| Activity 1 | 44.4 | 5 |

The process optimizer module 130 suggests that Activity 1 seems to be the most ineffective based on the obtained usefulness values 120 for each activity. Performing the activity 1 may not result in anything to the output module. Thus, an effective analysis of the activities is performed and the activity with the least usefulness is eliminated.

The sub modules of the processor optimizer module 130 are illustrated in FIG. 3. The sub modules of the processor optimizer module 130 comprise a computing module 302, and an optimizer module 304. The processor optimizer module 130 processes the effectiveness value 118 and an associated value of the activity to compute a usefulness value 120 for each activity. The associated value is total number of times an activity is performed on the one or more projects. The optimizer module 304 receives the usefulness value 120 associated with each activity and eliminates an activity with a least usefulness value, thereby optimizing the software testing process.

Referring back to FIG. 1, the testing process computing system comprises other modules 132 which are used for generating one or more reports based on the computed values by other modules. In one embodiment, the report comprises plurality of activities, effectiveness value associated with each activity, usefulness value associated with each activity and any other value determined by the testing process computing device. Further, the generated reports are transmitted to other users by one of sharing in a form of share point system and sending an email to key stakeholders or users, about various risk level associated with each projects.

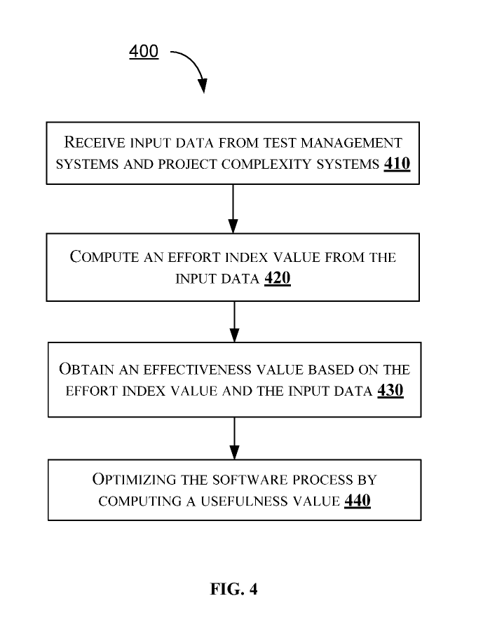

FIG. 4 shows a flowchart illustrating a method for optimizing software testing process in accordance with some embodiments of the present disclosure.

As illustrated in FIG. 4, the method 400 comprises one or more blocks for optimizing software testing process 100. The method 400 may be described in the general context of computer executable instructions. Generally, computer executable instructions can include routines, programs, objects, components, data structures, procedures, modules, and functions, which perform particular functions or implement particular abstract data types.

The order in which the method 400 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At block 410, receive the input data 114 from the test management system 102A and project complexity system 102B. In an embodiment, the input module 124 receives the input data 114 from the test management system 102. The input module 124 identifies the received input data from at least one or more test management system and any application testing module.

At block 420, compute an effort index value 116 by correlating the input data 114 based on at least one parameter associated with the one or more project complexity systems. The effort index value is computed by an effort analyzer 126 based on the input data 114 received from the input module 124. The input data 114 is co-related and then normalized. The effort analyzer 126 performs computation of effort based on the project complexity received from the input module 124 through project complexity system 102B.

At block 430, obtain an effectiveness value 118 based on the computed effort index value 116 and the input data 114. The process effectivizer module 128 receives the computed effort index value from the effort analyzer 126 and the input data, to calculate the overall effectiveness of the activity based on the complexity and normalized effort of the one or more projects. Then, an effectiveness value 118 for each activity is obtained by computing an average of intermediate effectiveness values associated with an activity for one or more projects.

At block 440, compute a usefulness value associated with the input data and the effectiveness value for each activity, and eliminating the activity with the least usefulness value thereby optimizing the software testing process. The process optimizer module 130 computes the usefulness of each activity using the effectiveness value 118 associated with each activity and total number of times activity was performed based on historical reference data.

Thus, the method and the device optimize software testing process, by determining a usefulness value for each activity associated with the one or more projects of a testing process and eliminating the activity with the least value.

### Computer System

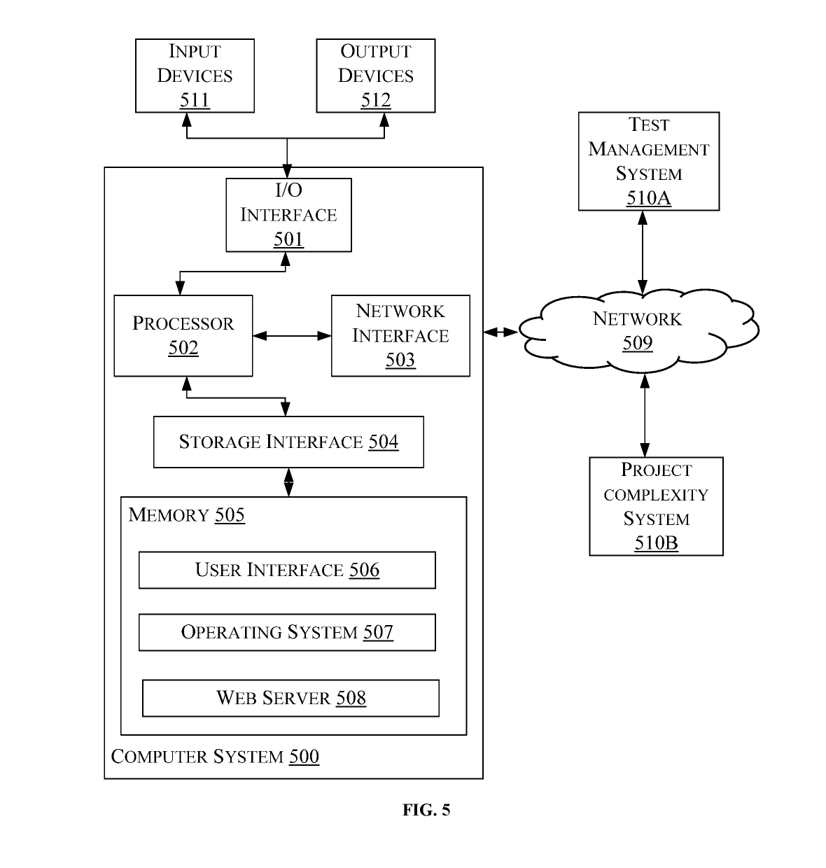

FIG. 5 illustrates a block diagram of an exemplary computer system 500 for implementing embodiments consistent with the present disclosure. In an embodiment, the computer system 500 is used to implement the testing process computing device 100. The computer system 500 computes a usefulness value associated with the input data of one or more projects of application/software testing process and optimizes application/software testing process. The computer system 500 may comprise a central processing unit (“CPU” or “processor”) 502. The processor 502 may comprise at least one data processor for executing program components for executing user- or system-generated business processes. A user may include a person, a person using a device such as such as those included in this disclosure, or such a device itself. The processor 502 may include specialized processing units such as integrated system (bus) controllers, memory management control units, floating point units, graphics processing units, digital signal processing units, etc.

The processor 502 may be disposed in communication with one or more input/output (I/O) devices (511 and 512) via I/O interface 501. The I/O interface 501 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 501, the computer system 500 may communicate with one or more I/O devices (511 and 512). For example, the input device 511 may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output device 512 may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

In some embodiments, the processor 502 may be disposed in communication with a communication network 509 via a network interface 503. The network interface 503 may communicate with the communication network 509. The network interface 503 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 509 may include, without limitation, a direct interconnection, local area network (LAN), wide area network (WAN), wireless network (e.g., using Wireless Application Protocol), the Internet, etc. Using the network interface 503 and the communication network 509, the computer system 500 may communicate with test management system 510A and project complexity system 510B.

In some embodiments, the processor 502 may be disposed in communication with a memory 505 (e.g., RAM, ROM, etc. not shown in FIG. 5) via a storage interface 504. The storage interface 504 may connect to memory 505 including, without limitation, memory drives, removable disc drives, etc., employing connection protocols such as serial advanced technology attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 505 may store a collection of program or database components, including, without limitation, user interface application 506, an operating system 507, web server 508 etc. In some embodiments, computer system 500 may store user/application data 506, such as the data, variables, records, etc. as described in this disclosure. Such databases may be implemented as fault-tolerant, relational, scalable, secure databases such as Oracle or Sybase.

The operating system 507 may facilitate resource management and operation of the computer system 500. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 506 may facilitate display, execution, interaction, manipulation, or operation of program components through textual or graphical facilities. For example, user interfaces may provide computer interaction interface elements on a display system operatively connected to the computer system 500, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 500 may implement a web browser 508 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 500 may implement a mail server stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as Internet Message Access Protocol (IMAP), Messaging Application Programming Interface (MAPI), Microsoft Exchange, Post Office Protocol (POP), Simple Mail Transfer Protocol (SMTP), or the like. In some embodiments, the computer system 500 may implement a mail client stored program component. The mail client may be a mail viewing application, such as Apple Mail, Microsoft Entourage, Microsoft Outlook, Mozilla Thunderbird, etc.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, nonvolatile memory, hard drives, CD ROMs, DVDs, flash drives, disks, and any other known physical storage media.

Advantages of the embodiment of the present disclosure are illustrated herein.

In an embodiment, the present disclosure provides a solution which is very simple to use.

In an embodiment, the present disclosure provides a solution, which is easy to implement.

In an embodiment, the present disclosure provides a methodical approach of how to identify the ineffective process for optimizing the testing process.

The described operations may be implemented as a method, system or article of manufacture using standard programming and/or engineering techniques to produce software, firmware, hardware, or any combination thereof. The described operations may be implemented as code maintained in a “non-transitory computer readable medium”, where a processor may read and execute the code from the computer readable medium. The processor is at least one of a microprocessor and a processor capable of processing and executing the queries. A non-transitory computer readable medium may comprise media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. Further, non-transitory computer-readable media comprise all computer-readable media except for a transitory. The code implementing the described operations may further be implemented in hardware logic (e.g., an integrated circuit chip, Programmable Gate Array (PGA), Application Specific Integrated Circuit (ASIC), etc.).

Still further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a non-transitory computer readable medium at the receiving and transmitting stations or devices. An “article of manufacture” comprises non-transitory computer readable medium, hardware logic, and/or transmission signals in which code may be implemented. A device in which the code implementing the described embodiments of operations is encoded may comprise a computer readable medium or hardware logic. Of course, those skilled in the art will recognize that many modifications may be made to this configuration without departing from the scope of the invention, and that the article of manufacture may comprise suitable information bearing medium known in the art.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIG. 4 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method for optimizing a software testing process, comprising:
receiving, by a testing process computing device, input data associated with one or more projects from one or more test management systems and one or more project complexity systems;
computing, by the testing process computing device, an effort index value by correlating the input data based on at least one parameter associated with the one or more project complexity systems;
obtaining, by the testing process computing device, an effectiveness value based on the effort index value and the input data; and
determining, by the testing process computing device, a usefulness value associated with the input data and the effectiveness value to optimize the software testing process.

2. The method as claimed in claim 1, wherein the input data is comprises at least one of a number of defects, a number of activities, a number of test cases, an amount of effort or a complexity value.

3. The method as claimed in claim 1, wherein computing the effort index value further comprises:
identifying, by the testing process computing device, a complexity value associated with each of the one or more projects; and
normalizing, by the testing process computing device, the complexity values associated with each of the one or more projects to compute the effort index value for each activity associated with each of the one or more projects.

4. The method as claimed in claim 1, wherein obtaining the effectiveness value further comprises:
determining, by the testing process computing device, an intermediate effectiveness value for each activity of the one or more projects using a number of test cases, a number of defects, and the effort index value associated with corresponding activity of the one or projects; and
computing, by the testing process computing device, an average of intermediate effectiveness values associated with an activity for the one or more projects to obtain the effectiveness value of each activity.

5. The method as claimed in claim 1, further comprising:
computing, by the testing process computing device, the usefulness value for each activity, using the effectiveness value and an associated value of the activity, wherein the associated value is total number of times an activity is performed on the one or more projects; and
eliminating, by the testing process computing device, an activity with a least usefulness value.

6. The method as claimed in claim 1 further comprising:
generating, by the testing process computing device, one or more reports comprising at least a plurality of activities, the effectiveness value associated with each activity, and the usefulness value associated with each activity.

7. A testing process computing device comprising a processor and a memory coupled to the processor which is configured to execute one or more programmed instructions comprising and stored in the memory to:
receive input data associated with one or more projects from one or more test management systems and one or more project complexity systems;
compute an effort index value by correlating the input data based on at least one parameter associated with the one or more project complexity systems;
obtain an effectiveness value based on the effort index value and the input data; and
determine a usefulness value associated with the input data and the effectiveness value to optimize a software testing process.

8. The device as claimed in claim 7, wherein the input data is comprises at least one of a number of defects, a number of activities, a number of test cases, an amount of effort or a complexity value.

9. The device as claimed in claim 7, wherein the processor coupled to the memory is further configured to execute at least one additional programmed instruction comprising and stored in the memory to:
identify a complexity value associated with each of the one or more projects; and
normalize the complexity values associated with each of the one or more projects to compute the effort index value for each activity associated with each of the one or more projects.

10. The device as claimed in claim 7, wherein the processor coupled to the memory is further configured to execute at least one additional programmed instruction comprising and stored in the memory to:
determine an intermediate effectiveness value for each activity of the one or more projects using a number of test cases, a number of defects, and the effort index value associated with corresponding activity of the one or projects; and
compute an average of intermediate effectiveness values associated with an activity for the one or more projects to obtain the effectiveness value of each activity.

11. The device as claimed in claim 7, wherein the processor coupled to the memory is further configured to execute at least one additional programmed instruction comprising and stored in the memory to:
compute the usefulness value for each activity, using the effectiveness value and an associated value of the activity, wherein the associated value is total number of times an activity is performed on the one or more projects; and
eliminate an activity with a least usefulness value.

12. The device as claimed in claim 7 wherein the processor coupled to the memory is further configured to execute at least one additional programmed instruction comprising and stored in the memory to:
generate one or more reports comprising at least a plurality of activities, the effectiveness value associated with each activity, and the usefulness value associated with each activity.

13. A non-transitory computer readable medium having stored thereon instructions for optimizing a software testing process comprising executable code which when executed by a processor, causes the processor to perform steps comprising:
receiving input data associated with one or more projects from one or more test management systems and one or more project complexity systems;
computing an effort index value by correlating the input data based on at least one parameter associated with the one or more project complexity systems;
obtaining an effectiveness value based on the effort index value and the input data; and
determining a usefulness value associated with the input data and the effectiveness value to optimize the software testing process.

14. The medium as claimed in claim 13, wherein the input data is comprises at least one of a number of defects, a number of activities, a number of test cases, an amount of effort or a complexity value.

15. The medium as claimed in claim 13 further having stored thereon at least one additional instruction that when executed by the processor causes the processor to perform at least one additional step comprising:
identifying a complexity value associated with each of the one or more projects; and
normalizing the complexity values associated with each of the one or more projects to compute the effort index value for each activity associated with each of the one or more projects.

16. The medium as claimed in claim 13 further having stored thereon at least one additional instruction that when executed by the processor causes the processor to perform at least one additional step comprising:
determining an intermediate effectiveness value for each activity of the one or more projects using a number of test cases, a number of defects, and the effort index value associated with corresponding activity of the one or projects; and
computing an average of intermediate effectiveness values associated with an activity for the one or more projects to obtain the effectiveness value of each activity.

17. The medium as claimed in claim 13 further having stored thereon at least one additional instruction that when executed by the processor causes the processor to perform at least one additional step comprising:
computing the usefulness value for each activity, using the effectiveness value and an associated value of the activity, wherein the associated value is total number of times an activity is performed on the one or more projects; and
eliminating an activity with a least usefulness value.

18. The medium as claimed in claim 13 further having stored thereon at least one additional instruction that when executed by the processor causes the processor to perform at least one additional step comprising:
generating one or more reports comprising at least a plurality of activities, the effectiveness value associated with each activity, and the usefulness value associated with each activity.
